(19) United States
(12) Patent Application Publication
(10) Pub. No.: US 2014/0379207 A1
(43) Pub. Date: Dec. 25, 2014

(54) SYSTEMS AND METHODS FOR TRANSFORMING SENSORY MEASUREMENTS OF A HANDHELD DEVICE LOCATED IN MOVING VEHICLE FROM DEVICE'S COORDINATE SYSTEM TO THAT OF A VEHICLE

(71) Applicant: IGOR KATSMAN, Haifa (IL)

(72) Inventor: IGOR KATSMAN, Haifa (IL)

(21) Appl. No.: 14/260,279

(22) Filed: Apr. 23, 2014

Related U.S. Application Data
(60) Provisional application No. 61/815,061, filed on Apr. 23, 2013.

(51) Int. Cl. G01M 17/007

(52) U.S. Cl. CPC G01M 17/007
USPC 701/33.2

(57) ABSTRACT

A method of operating a general purpose handheld communication device to transform sensory measurements of a handheld device located in moving vehicle from device's coordinate system to that of a vehicle, the handheld communication device including GPS sensor, accelerometer sensor, gyroscope sensor, magnetometer sensor, data processor and data storage medium, the method comprising: identifying a vertical and horizontal acceleration component in car based coordinate system; and identifying strong change in speed and in heading in the car coordinate system; identifying the orientation of the handheld device relative to the vehicle orientation; and transforming sensory measurements of a handheld device located in moving vehicle from device's coordinate system to that of a vehicle, which further enables a detection of driving maneuvers in the car based coordinate system.

### CROSS-REFERENCE TO RELATED PATENT APPLICATION

The present regular U.S. patent application relies upon, claims the benefit of priority from, and is a non-provisional of U.S. provisional patent application No. 61/815,061 filed on Apr. 23, 2013, the entire disclosure of which is incorporated by reference herein. This U.S. patent application is also related to co-pending U.S. patent application entitled “SYSTEMS AND METHODS FOR HANDHELD DEVICE BASED BATTERY EFFICIENT CONTEXT MONITORING, DETECTION OF A VEHICULAR MOTION AND IDENTIFICATION OF A SPECIFIC VEHICLE” filed on the same day, the entire disclosure of which is incorporated by reference herein.

### BACKGROUND OF THE INVENTION

1. Technical Field

The disclosed embodiments relate in general to vehicle monitoring and more specifically to systems and methods for transforming sensory measurements of a handheld device located in moving vehicle from device's coordinate system to that of a vehicle.

2. Description of the Related Art

As would be appreciated by persons of ordinary skill in the art, monitoring motion parameters of a motor vehicle may be performed using a handheld computing (communication) device, such as smartphone or table computer placed in or about the vehicle. However, given the potentially changing orientation and position of a handheld device located in moving vehicle, the transforming device's sensory measurements from device's coordinate system to that of a vehicle is an important and challenging task. By measuring the sensory measurements in the device's coordinate system and transforming to that of a vehicle, this task enables automatic assessment of the driving skills, which are defined as a set of driving maneuvers in the car coordinate system.

An example of driving maneuver can be hard braking, sharp cornering, fast acceleration, which are all measured in the vehicle coordinate system.

OBD-2 based devices, attached at fixed orientation to a car onboard diagnostic port, read speed from OBD port and can be calibrated at installation time with regards to the constant orientation of the device relative to the car, enabling simple transformation of device's sensory measurements from device's coordinate system to that of a car.

GPS sensory data, acquired by handheld device, is delivered in earth coordinate system and is easily to transform to a car coordinate system. The accuracy of GPS data is typically poor and can change with location, weather conditions, phone model, etc. Thus, GPS data cannot be to be reliably used as a sole data source for detection of driving maneuvers.

Motions sensors (i.e. accelerometers) and orientation sensors (i.e. gyroscope) are by nature much more reliable sources of data (i.e. acceleration, rotation, etc.) and are more suitable to be reliably used as a data source for detection of driving maneuvers.

In general case, the orientation and position of a handheld device located in moving vehicle can take arbitrary values at the trip start. For example, a handheld device can be arbitrary oriented and located in the pocket, or in the backpack, or on holder, or other position and orientation.

Furthermore, the orientation and position of a handheld device located in moving vehicle can change along the driving trip. For example, a phone can change its location and orientation because driver can take it out of the pocket and place on the dashboard holder, or can move or re-orient the backpack with the phone inside.

Thus, calculation of the orientation of a handheld device located in moving vehicle relative to the vehicle orientation becomes an important task that should be performed at any given time along the trip.

A modern handheld device includes many advanced hardware components. For instance, some smartphones include components with capabilities similar to those of a simple personal computer, e.g., random access memory (RAM), data storage media, CPU, graphics accelerator, and alphanumeric keypad. In addition, a phone may include such components as motion sensors (i.e. accelerometers, etc.), orientation sensors (gyroscopes, magnetometers, etc.), light sensors, pressure sensors, GPS hardware component, network-based position estimation component, one or more video cameras, networking and Internet capability, remote component connectivity, high quality display, touch screen, battery, microphone, speakerphone, and other components.

Accordingly, new and improved systems and methods are needed that provide a handheld device based system for automatic calculation of handheld device's orientation relative to the vehicle orientation and monitor orientation changes along the trip. With the knowledge of relative orientation, the device's sensory measurements can be transformed from device's coordinate system to that of a vehicle and used for automatic assessment of the driving skills.

### SUMMARY OF THE INVENTION

The embodiments described herein are directed to methods and systems that substantially obviate one or more of the above and other problems associated with conventional systems and methods for vehicle monitoring.

In accordance with one aspect of the embodiments described herein, there is provided a computer-implemented method performed in connection with a handheld communication device, the method for transforming sensory measurements of the handheld communication device performed in a moving vehicle from a coordinate system of the handheld communication device to a coordinate system of the moving vehicle, the handheld communication device comprising a GPS sensor, an accelerometer sensor, a data processor and a data storage medium, the method comprising: acquiring acceleration data using the accelerometer sensor and applying a set of digital signal processing methods to the acquired acceleration data to identify a vertical direction of the coordinate system of the moving vehicle; applying a set of mathematical methods to the acquired acceleration data to identify a horizontal acceleration component in the coordinate system of the moving vehicle; acquiring speed and heading data using the GPS sensor, and applying a set of digital signal processing methods to the acquired speed and heading data to identify periods of substantial change in speed, and substantial change in heading in the coordinate system of the moving vehicle; storing the acquired acceleration, speed, and heading data to the data storage medium; analyzing a sequence of the stored acceleration, speed and heading data and applying a set of digital signal processing methods to identify an orientation of the handheld communication device relative to a vehicle orientation; and transforming sensory measurements of the handheld communication device located in or about the moving vehicle from the coordinate system of the handheld communication device to the coordinate system of the moving vehicle.

In one or more embodiments, the computer-implemented method further comprises using the transformed sensory measurements of the handheld communication device located in or about the moving vehicle from the coordinate system of the handheld communication device to the coordinate system of the moving vehicle for detection of driving maneuvers in the coordinate system of the moving vehicle.

In one or more embodiments, the handheld communication device further comprises an orientation sensor and the computer-implemented method further comprises: acquiring orientation data using the orientation sensor; storing the acquired orientation data on the data storage medium; continuously processing the acquired orientation data using a digital signal processing to monitor the orientation of the handheld communication device relative to the vehicle orientation; and if change in the orientation of the handheld communication device relative to the vehicle orientation is detected, automatically recalculating a new orientation of the handheld communication device relative to the vehicle orientation.

In accordance with another aspect of the embodiments described herein, there is provided a non-transitory computer readable medium embodying a set of computer executable instructions, which, when executed in connection with a handheld communication device comprising a GPS sensor, an accelerometer sensor, a data processor and a data storage medium, causes the handheld communication device to perform a method for transforming sensory measurements of the handheld communication device performed in a moving vehicle from a coordinate system of the handheld communication device to a coordinate system of the moving vehicle, the method comprising: acquiring acceleration data using the accelerometer sensor and applying a set of digital signal processing methods to the acquired acceleration data to identify a vertical direction of the coordinate system of the moving vehicle; applying a set of mathematical methods to the acquired acceleration data to identify a horizontal acceleration component in the coordinate system of the moving vehicle; acquiring speed and heading data using the GPS sensor, and applying a set of digital signal processing methods to the acquired speed and heading data to identify periods of substantial change in speed, and substantial change in heading in the coordinate system of the moving vehicle; storing the acquired acceleration, speed, and heading data to the data storage medium; analyzing a sequence of the stored acceleration, speed and heading data and applying a set of digital signal processing methods to identify an orientation of the handheld communication device relative to a vehicle orientation; and transforming sensory measurements of the handheld communication device located in or about the moving vehicle from the coordinate system of the handheld communication device to the coordinate system of the moving vehicle.

In one or more embodiments, the method further comprises using the transformed sensory measurements of the handheld communication device located in or about the moving vehicle from the coordinate system of the handheld communication device to the coordinate system of the moving vehicle for detection of driving maneuvers in the coordinate system of the moving vehicle.

In one or more embodiments, the handheld communication device further comprises an orientation sensor and the method further comprises: acquiring orientation data using the orientation sensor; storing the acquired orientation data on the data storage medium; continuously processing the acquired orientation data using a digital signal processing to monitor the orientation of the handheld communication device relative to the vehicle orientation; and if change in the orientation of the handheld communication device relative to the vehicle orientation is detected, automatically recalculating a new orientation of the handheld communication device relative to the vehicle orientation.

In accordance with yet another aspect of the embodiments described herein, there is provided a handheld communication device comprising a GPS sensor, an accelerometer sensor, a data processor and a data storage medium, the data storage medium storing a set of computer executable instructions, which cause the handheld communication device to perform a method for transforming sensory measurements of the handheld communication device performed in a moving vehicle from a coordinate system of the handheld communication device to a coordinate system of the moving vehicle, the method comprising: acquiring acceleration data using the accelerometer sensor and applying a set of digital signal processing methods to the acquired acceleration data to identify a vertical direction of the coordinate system of the moving vehicle; applying a set of mathematical methods to the acquired acceleration data to identify a horizontal acceleration component in the coordinate system of the moving vehicle; acquiring speed and heading data using the GPS sensor, and applying a set of digital signal processing methods to the acquired speed and heading data to identify periods of substantial change in speed, and substantial change in heading in the coordinate system of the moving vehicle; storing the acquired acceleration, speed, and heading data to the data storage medium; analyzing a sequence of the stored acceleration, speed and heading data and applying a set of digital signal processing methods to identify an orientation of the handheld communication device relative to a vehicle orientation; and transforming sensory measurements of the handheld communication device located in or about the moving vehicle from the coordinate system of the handheld communication device to the coordinate system of the moving vehicle.

In one or more embodiments, the method further comprises using the transformed sensory measurements of the handheld communication device located in or about the moving vehicle from the coordinate system of the handheld communication device to the coordinate system of the moving vehicle for detection of driving maneuvers in the coordinate system of the moving vehicle.

In one or more embodiments, the handheld communication device further comprises an orientation sensor and the method further comprises: acquiring orientation data using the orientation sensor; storing the acquired orientation data on the data storage medium; continuously processing the acquired orientation data using a digital signal processing to monitor the orientation of the handheld communication device relative to the vehicle orientation; and if change in the orientation of the handheld communication device relative to the vehicle orientation is detected, automatically recalculating a new orientation of the handheld communication device relative to the vehicle orientation.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a handheld communication device whereupon the various embodiments described herein may be implemented.

FIG. 2 illustrates an exemplary embodiment of a computer-implemented method 200 for calculating handheld device's orientation relative to the vehicle's orientation and monitoring orientation changes during the vehicle driving trip.

FIG. 3 illustrates another exemplary embodiment of a method performed by the handheld communication device.

FIG. 4 illustrates another exemplary embodiment of a handheld communication device whereupon the various embodiments described herein may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the embodiments described herein, there is provided a system and method of operating a general-purpose handheld communication device to calculate handheld device's orientation relative to the vehicle orientation and monitor orientation changes during the vehicle trip. Knowing the relative orientation enables one to automatically transform sensory measurements of a handheld device located in or about the moving vehicle from device's coordinate system to that of the vehicle.

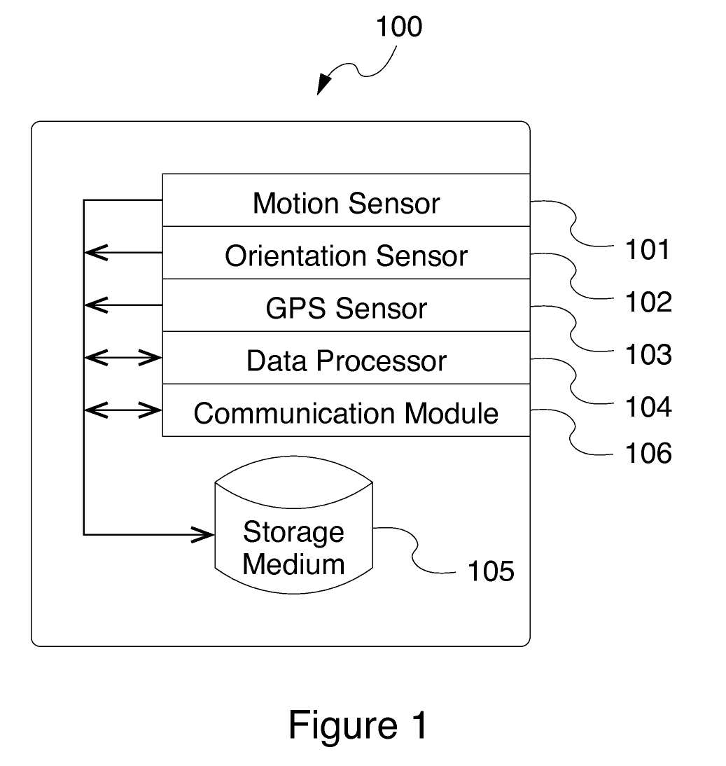

In one or more embodiments, the handheld communication device is located in a context of a potentially moving vehicle. An exemplary embodiment of a handheld communication device 100 is illustrated in FIG. 1. As shown in FIG. 1, the exemplary embodiment of the handheld communication device 100 may incorporate one or more motion sensors 101, such as accelerometers, one or more orientation sensors 102, such as gyroscopes or magnetometers, a GPS hardware component (sensor) 103, a data processor 104, a data storage medium 105 and data communication module 106. As would be appreciated by persons of skill in the art, the handheld communication device 100 may include various other components or modules as an alternative of in addition to the above-described components.

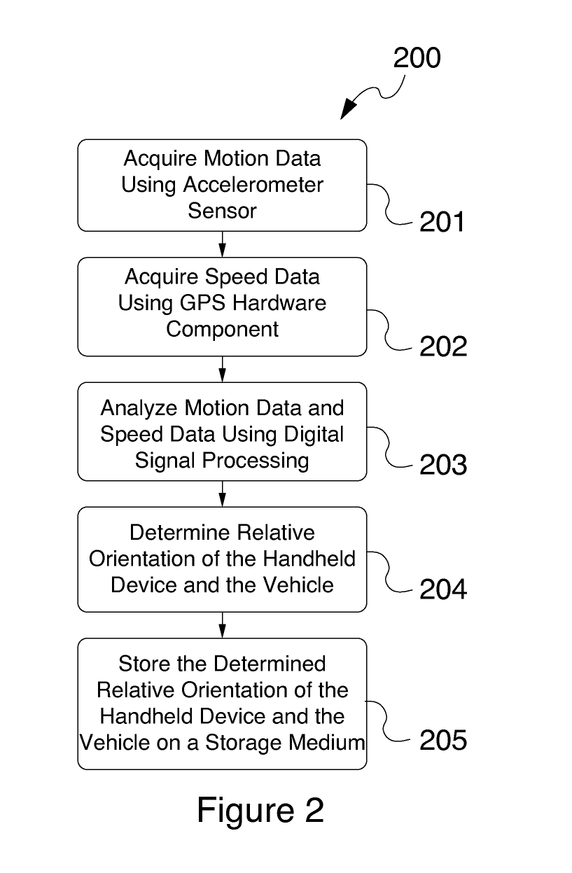

FIG. 2 illustrates an exemplary embodiment of a computer-implemented method 200 for calculating handheld device's orientation relative to the vehicle's orientation and monitoring orientation changes during the vehicle driving trip. As shown in FIG. 2, first, the method 200 involves acquiring motion data using the accelerometer sensor 101, see step 201. Subsequently, at step 202, speed data is acquired using the GPS hardware component. At step 203, the acquired motion data and speed data is analyzed using digital signal processing methods well known to persons of ordinary skill in the art. Based on the results of this analysis, at step 204, the orientation of the handheld device 100 relative to the vehicle orientation is determined. At step 205, the determined orientation data is stored in the data storage medium 105, whereupon the computer-implemented method 200 terminates. In one or more embodiments, the determined orientation data may be additionally transmitted to one or more network entities using the data communication module 106.

In one or more embodiments, the computer-implemented method 200 further includes a step of continuously monitoring of the orientation changes of the handheld communication device 100 relative to the vehicle orientation along the trip. To this end, the handheld communication device 100 is configured to continuously perform calculation of the orientation of the handheld communication device 100 relative to the vehicle orientation in accordance with the steps of the computer-implemented method 200 described above. In one or more embodiments, upon detection of pre-determined orientation changes, the handheld communication device 100 may be configured to perform predetermined action(s), such as generate an alert or transmit certain information to one or more network entities using the data communication module 106.

In one or more embodiments, the computer-implemented method 200 further includes a step of receiving an orientation data using the gyroscopic sensor 102 of the handheld communication device 100, analyzing the received orientation data using digital signal processing methods well known to persons of ordinary skill in the art and detecting the orientation of the handheld device relative to the vehicle orientation based on the results of the aforesaid analysis.

In one or more embodiments, the computer-implemented method 200 further includes a step of receiving an orientation data using the magnetometer sensor 102 of the handheld communication device 100, analyzing the received orientation data using digital signal processing methods well known to persons of ordinary skill in the art and detecting the orientation of the handheld device relative to the vehicle orientation based on the results of the aforesaid analysis.

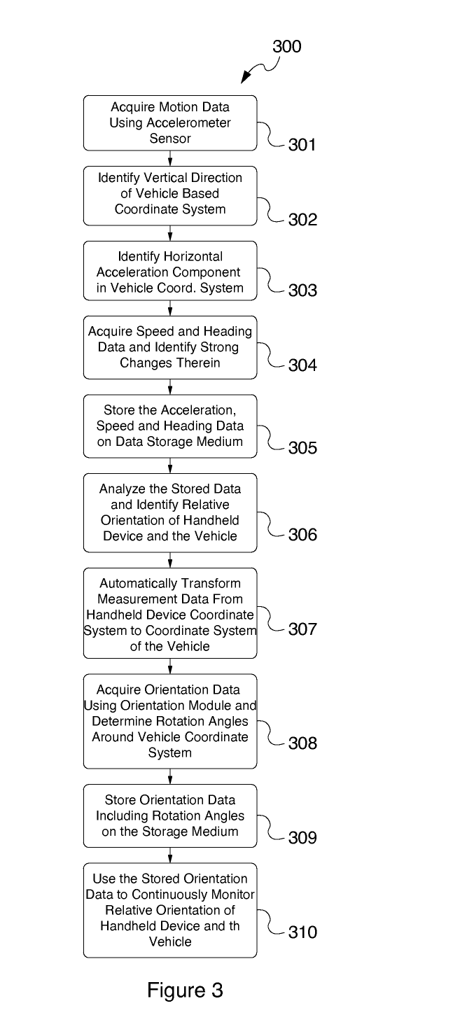

FIG. 3 illustrates another exemplary embodiment of a method 300 performed by the handheld communication device 100. First, at step 301, the handheld communication device 100 is configured to acquire acceleration data using the accelerometer sensor 101. At step 302, the handheld communication device 100 is configured to apply a set of digital signal processing methods well known to persons or ordinary skill in the art to identify a vertical direction of the vehicle based coordinate system. In one or more embodiments, the aforesaid set of digital signal processing methods contains, without limitation, techniques selected from a group of low pass filtering, computing running averages and the like.

At step 303, the handheld communication device 100 is configured to apply a set of mathematical methods to identify a horizontal acceleration component in the vehicle-based coordinate system. In one or more embodiments, the set of mathematical methods include, without limitation, techniques selected from a group of techniques that includes: matrix multiplication, matrix inversion, vector transformation and the like.

At step 304, the handheld communication device 100 is configured to acquire speed and heading data using the GPS sensor, and to apply a set of digital signal processing methods to identify periods of strong change in speed, indicating a significant acceleration force in the direction along the vehicle motion (horizontal longitudinal acceleration) and strong change in heading, indicating a significant acceleration force in the direction perpendicular to the vehicle motion (horizontal latitudinal acceleration) in the car coordinate system. In one or more embodiments, the set of digital signal processing methods contain one or more well-known in the art techniques selected from a group of techniques that includes: low pass filtering, averaging, numerical stabilization and the like.

At step 305, the handheld communication device 100 is configured to store data that includes the acquired acceleration, speed, and heading data to the data storage medium 105.

At step 306, the handheld communication device 100 is configured to analyze a sequence of the stored acceleration, speed and heading data and apply a set of digital signal processing methods to identify the orientation of the handheld communication device 100 relative to the vehicle orientation. In one or more embodiments, the set of digital signal processing methods contain wells known in the art techniques selected from a group of techniques that includes, without limitation: correlation, finding best alignment, noise filtering, numerical analysis and the like.

At step 307, the handheld communication device 100 is configured to automatically transform sensory measurements of a handheld communication device located in a moving vehicle from device's coordinate system to that of a vehicle, which further enables a detection of driving maneuvers in the vehicle-based coordinate system.

At step 308, the handheld communication device 100 is configured to acquire orientation data using the gyroscope and/or magnetometer orientation sensors, and to apply a set of digital signal processing methods to identify a rotation angles around vehicle based coordinate system. In one or more embodiments, the set of digital signal processing methods contain well known in the art techniques selected from a group of techniques that includes, without limitation: low pass filtering, high pass filtering, drift compensation, calculation of transformation matrix, running averaging and the like.

At step 309, the handheld communication device 100 is configured to store the orientation data that includes rotation angles along vehicle-based coordinate system on the data storage medium 105.

At step 310, the handheld communication device 100 is configured to use a sequence of the stored orientation data from the gyroscope and/or magnetometer orientation sensors 102 to monitor the orientation of the handheld device relative to the vehicle orientation. In one or more embodiments, if a change in the orientation of the handheld device relative to the vehicle orientation is detected, in response to such change detection, the handheld communication device 100 is configured to automatically recalculate the new orientation of the handheld device relative to the vehicle orientation.

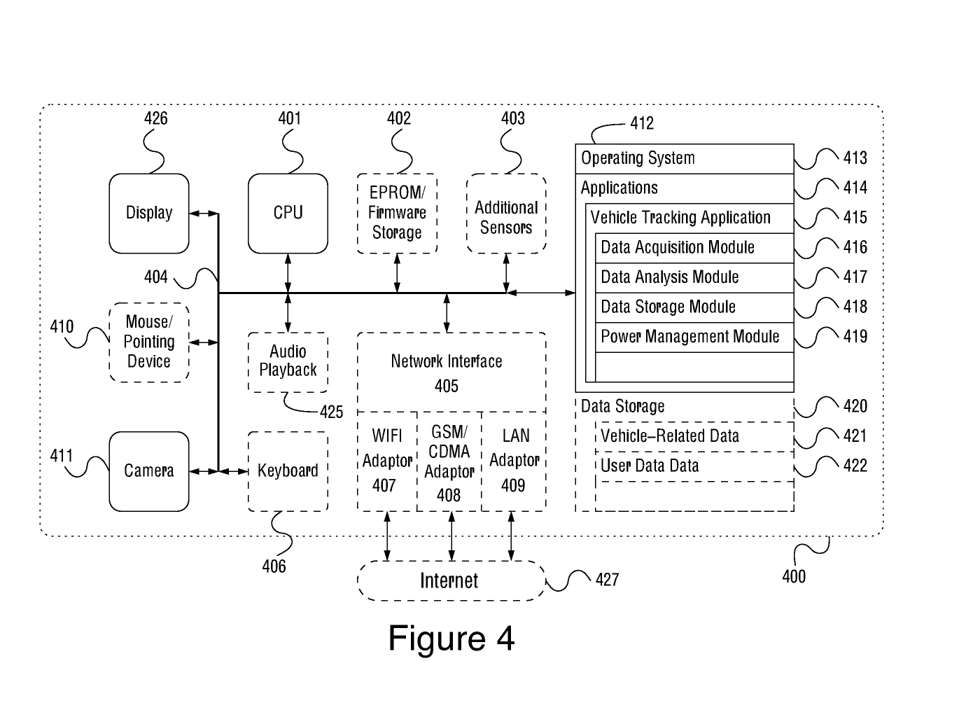

FIG. 4 illustrates an exemplary embodiment of mobile computerized system (handheld communication device) 400 for vehicle monitoring. In one or more embodiments, the computerized system 400 may be implemented within the form factor of a laptop or a notebook computer or a mobile computing device, such as a smartphone or a tablet computer.

The computerized system 400 may include a data bus 404 or other interconnect or communication mechanism for communicating information across and among various hardware components of the computerized system 400, and a central processing unit (CPU or simply processor) 401 electrically coupled with the data bus 404 for processing information and performing other computational and control tasks. Computerized system 400 also includes a memory 412, such as a random access memory (RAM) or other dynamic storage device, coupled to the data bus 404 for storing various information as well as instructions to be executed by the processor 401. The memory 412 may also include persistent storage devices, such as a magnetic disk, optical disk, solid-state flash memory device or other non-volatile solid-state storage devices.

In one or more embodiments, the memory 412 may also be used for storing temporary variables or other intermediate information during execution of instructions by the processor 401. Optionally, computerized system 400 may further include a read only memory (ROM or EPROM) 402 or other static storage device coupled to the data bus 404 for storing static information and instructions for the processor 401, such as firmware necessary for the operation of the computerized system 400, basic input-output system (BIOS), as well as various configuration parameters of the computerized system 400.

In one or more embodiments, the computerized system 400 may incorporate a display device 526, which may be also electrically coupled to the data bus 404, for displaying various information to a user of the computerized system 400, such as a user interface. In an alternative embodiment, the display device 426 may be associated with a graphics controller and/or graphics processor (not shown). The display device 426 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 426 may be incorporated into the same general enclosure with the remaining components of the computerized system 400. In an alternative embodiment, the display device 426 may be positioned outside of such enclosure, such as on the surface of a table or a desk. In one or more embodiments, the computerized system 400 may further incorporate a projector or mini-projector (not shown) configured to project information, such as the aforesaid user interface(s), onto a display surface.

In one or more embodiments, the computerized system 400 may further incorporate an audio playback device 425 electrically connected to the data bus 404 and configured to play various audio files, such as MPEG-3 files, or audio tracks of various video files, such as MPEG-4 files, well known to persons of ordinary skill in the art. To this end, the computerized system 400 may also incorporate waive or sound processor or a similar device (not shown).

In one or more embodiments, the computerized system 400 may incorporate one or more input devices, such as a mouse/pointing device 410, such as a mouse, a trackball, a touchpad, or cursor direction keys for communicating direction information and command selections to the processor 401 and for controlling cursor movement on the display 426. This input device typically has two degrees of freedom in two axes, a first axis (e.g., x) and a second axis (e.g., y), that allows the device to specify positions in a plane.

The computerized system 400 may further incorporate a camera 411 for acquiring still images and video of various objects, which all may be coupled to the data bus 404 for communicating information, including, without limitation, images and video, as well as user commands (including gestures) to the processor 401.

The computerized system 400 may further incorporate additional sensors 403, such as various location, motion or orientation sensors described above.

In one or more embodiments, the computerized system 400 may additionally include a communication interface, such as a network interface 405 coupled to the data bus 404. The network interface 405 may be configured to establish a connection between the computerized system 400 and the Internet 427 using at least one of a WIFI interface 407, a cellular network (GSM or CDMA) adaptor 408 and/or local area network (LAN) adaptor 409. The network interface 405 may be configured to enable a two-way data communication between the computerized system 400 and the Internet 427. The WIFI adaptor 407 may operate in compliance with 802.11a, 802.11b, 802.11g and/or 802.11n protocols as well as Bluetooth protocol well known to persons of ordinary skill in the art. The LAN adaptor 409 of the computerized system 400 may be implemented, for example, using an integrated services digital network (ISDN) card or a modem to provide a data communication connection to a corresponding type of telephone line, which is interfaced with the Internet 427 using Internet service provider's hardware (not shown). As another example, the LAN adaptor 409 may be a local area network interface card (LAN NIC) to provide a data communication connection to a compatible LAN and the Internet 427. In an exemplary implementation, the WIFI adaptor 407, the cellular network (GSM or CDMA) adaptor 408 and/or the LAN adaptor 409 send and receive electrical or electromagnetic signals that carry digital data streams representing various types of information.

In one or more embodiments, the Internet 427 typically provides data communication through one or more sub-networks to other network resources. Thus, the computerized system 400 is capable of accessing a variety of network resources located anywhere on the Internet 427, such as remote media servers, web servers, other content servers as well as other network data storage resources. In one or more embodiments, the computerized system 400 is configured to send and receive messages, media and other data, including video files and application program code, through a variety of network(s) including the Internet 427 by means of the network interface 405. In the Internet example, when the computerized system 400 acts as a network client, it may request code or data for an application program executing on the computerized system 400. Similarly, it may, as a server, send various data or computer code to other network resources.

In one or more embodiments, the functionality described herein is implemented by computerized system 400 in response to processor 401 executing one or more sequences of one or more instructions contained in the memory 412. Such instructions may be read into the memory 412 from another computer-readable medium. Execution of the sequences of instructions contained in the memory 412 causes the processor 401 to perform the various process steps described herein. In alternative embodiments, hard-wired circuitry may be used in place of or in combination with software instructions to implement the embodiments of the invention. Thus, the described embodiments of the invention are not limited to any specific combination of hardware circuitry and/or software.

The term “computer-readable medium” as used herein refers to any medium that participates in providing instructions to the processor 401 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to the processor 401 for execution. For example, the instructions may initially be carried on a magnetic disk from a remote computer. Alternatively, a remote computer can load the instructions into its dynamic memory and send the instructions over the Internet 427. Specifically, the computer instructions may be downloaded into the memory 412 of the computerized system 400 from the foresaid remote computer via the Internet 427 using a variety of network data communication protocols well known in the art.

In one or more embodiments, the memory 412 of the computerized system 400 may store any of the following software programs, applications or modules:

1. Operating system (OS) 413 for implementing basic system services and managing various hardware components of the computerized system 400. Exemplary embodiments of the operating system 413 are well known to persons of skill in the art, and may include any now known or later developed operating systems.

2. Applications 414 may include, for example, a set of software applications executed by the processor 401 of the computerized system 400, which cause the computerized system 400 to perform certain predetermined functions. In one or more embodiments, the applications 414 may include an inventive vehicle monitoring application 415.

3. Data storage 420 may include, for example, a vehicle-related data storage 421 for storing various data related to vehicle motion and operation as well as user data storage 422.

In one or more embodiments, the inventive vehicle monitoring application 415 incorporates a data acquisition module 416 for acquiring various data using sensors of the computing device 400, a data analysis module 417 for analyzing the acquired data, a data storage module 418 for storing vehicle-related data in the storage medium as well as power management module 419 for effectively managing the power of the computing device 400.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for vehicle monitoring. It is intended that the specification and examples be considered as exemplary only, with a true scope and spirit of the invention being indicated by the following claims.

What is claimed is:

1. A computer-implemented method performed in connection with a handheld communication device, the method for transforming sensory measurements of the handheld communication device performed in a moving vehicle from a coordinate system of the handheld communication device to a coordinate system of the moving vehicle, the handheld communication device comprising a GPS sensor, an accelerometer sensor, a data processor and a data storage medium, the method comprising:
acquiring acceleration data using the accelerometer sensor and applying a set of digital signal processing methods to the acquired acceleration data to identify a vertical direction of the coordinate system of the moving vehicle;
applying a set of mathematical methods to the acquired acceleration data to identify a horizontal acceleration component in the coordinate system of the moving vehicle;
acquiring speed and heading data using the GPS sensor, and applying a set of digital signal processing methods to the acquired speed and heading data to identify periods of substantial change in speed, and substantial change in heading in the coordinate system of the moving vehicle;
storing the acquired acceleration, speed, and heading data to the data storage medium;
analyzing a sequence of the stored acceleration, speed and heading data and applying a set of digital signal processing methods to identify an orientation of the handheld communication device relative to a vehicle orientation; and
transforming sensory measurements of the handheld communication device located in or about the moving vehicle from the coordinate system of the handheld communication device to the coordinate system of the moving vehicle.

2. The computer-implemented method of claim 1, further comprising using the transformed sensory measurements of the handheld communication device located in or about the moving vehicle from the coordinate system of the handheld communication device to the coordinate system of the moving vehicle for detection of driving maneuvers in the coordinate system of the moving vehicle.

3. The computer-implemented method of claim 1, wherein the handheld communication device further comprises an orientation sensor, the computer-implemented method further comprises: acquiring orientation data using the orientation sensor; storing the acquired orientation data on the data storage medium; continuously processing the acquired orientation data using a digital signal processing to monitor the orientation of the handheld communication device relative to the vehicle orientation; and if change in the orientation of the handheld communication device relative to the vehicle orientation is detected, automatically recalculating a new orientation of the handheld communication device relative to the vehicle orientation.

4. A non-transitory computer readable medium embodying a set of computer executable instructions, which, when executed in connection with a handheld communication device comprising a GPS sensor, an accelerometer sensor, a data processor and a data storage medium, causes the handheld communication device to perform a method for transforming sensory measurements of the handheld communication device performed in a moving vehicle from a coordinate system of the handheld communication device to a coordinate system of the moving vehicle, the method comprising:
acquiring acceleration data using the accelerometer sensor and applying a set of digital signal processing methods to the acquired acceleration data to identify a vertical direction of the coordinate system of the moving vehicle;
applying a set of mathematical methods to the acquired acceleration data to identify a horizontal acceleration component in the coordinate system of the moving vehicle;
acquiring speed and heading data using the GPS sensor, and applying a set of digital signal processing methods to the acquired speed and heading data to identify periods of substantial change in speed, and substantial change in heading in the coordinate system of the moving vehicle;
storing the acquired acceleration, speed, and heading data to the data storage medium;
analyzing a sequence of the stored acceleration, speed and heading data and applying a set of digital signal processing methods to identify an orientation of the handheld communication device relative to a vehicle orientation; and
transforming sensory measurements of the handheld communication device located in or about the moving vehicle from the coordinate system of the handheld communication device to the coordinate system of the moving vehicle.

5. The non-transitory computer readable medium of claim 4, wherein the method further comprises using the transformed sensory measurements of the handheld communication device located in or about the moving vehicle from the coordinate system of the handheld communication device to the coordinate system of the moving vehicle for detection of driving maneuvers in the coordinate system of the moving vehicle.

6. The non-transitory computer readable medium of claim 1, wherein the handheld communication device further comprises an orientation sensor and wherein the computer-implemented method further comprises: acquiring orientation data using the orientation sensor; storing the acquired orientation data on the data storage medium; continuously processing the acquired orientation data using a digital signal processing to monitor the orientation of the handheld communication device relative to the vehicle orientation; and if change in the orientation of the handheld communication device relative to the vehicle orientation is detected, automatically recalculating a new orientation of the handheld communication device relative to the vehicle orientation.

7. A handheld communication device comprising a GPS sensor, an accelerometer sensor, a data processor and a data storage medium, the data storage medium storing a set of computer executable instructions, which cause the handheld communication device to perform a method for transforming sensory measurements of the handheld communication device performed in a moving vehicle from a coordinate system of the handheld communication device to a coordinate system of the moving vehicle, the method comprising:
acquiring acceleration data using the accelerometer sensor and applying a set of digital signal processing methods to the acquired acceleration data to identify a vertical direction of the coordinate system of the moving vehicle;
applying a set of mathematical methods to the acquired acceleration data to identify a horizontal acceleration component in the coordinate system of the moving vehicle;
acquiring speed and heading data using the GPS sensor, and applying a set of digital signal processing methods to the acquired speed and heading data to identify periods of substantial change in speed, and substantial change in heading in the coordinate system of the moving vehicle;
storing the acquired acceleration, speed, and heading data to the data storage medium;
analyzing a sequence of the stored acceleration, speed and heading data and applying a set of digital signal processing methods to identify an orientation of the handheld communication device relative to a vehicle orientation; and
transforming sensory measurements of the handheld communication device located in or about the moving vehicle from the coordinate system of the handheld communication device to the coordinate system of the moving vehicle.

8. The handheld communication device of claim 7, wherein the method further comprises using the transformed sensory measurements of the handheld communication device located in or about the moving vehicle from the coordinate system of the handheld communication device to the coordinate system of the moving vehicle for detection of driving maneuvers in the coordinate system of the moving vehicle.

9. The handheld communication device of claim 7, further comprising an orientation sensor and wherein the method further comprises: acquiring orientation data using the orientation sensor; storing the acquired orientation data on the data storage medium; continuously processing the acquired orientation data using a digital signal processing to monitor the orientation of the handheld communication device relative to the vehicle orientation; and if change in the orientation of the handheld communication device relative to the vehicle orientation is detected, automatically recalculating a new orientation of the handheld communication device relative to the vehicle orientation.
